(19) United States
(12) Patent Application Publication
(10) Pub. No.: US 2012/0288846 A1
(43) Pub. Date: Nov. 15, 2012

(54) E-LEARNING CONTENT MANAGEMENT AND DELIVERY SYSTEM

(76) Inventor: Jacqueline Breanne Hull, Austin, TX (US)

(21) Appl. No.: 13/421,829

(22) Filed: Mar. 15, 2012

Related U.S. Application Data
(60) Provisional application No. 61/452,713, filed on Mar. 15, 2011.

(51) Int. Cl. G09B 25/00

(52) U.S. Cl. 434/365

(57) ABSTRACT

The present disclosure teaches a method and system for improving delivery of educational content. The content delivery system is based on best practices in classroom instruction, transferred into an online learning format. The lesson format includes short bursts of video-based instruction, interrupted by formative assessment in the form of multiple choice and multiple answer questions, in the same way a teacher would teach in a classroom. The system enables educators to import their own direct instruction content in the form of videos and add in their own questions and answer choices throughout the lesson, where appropriate. Further, the educator is also able to create his or her own summative assessment question items that incorporate material from multiple lessons. The educator also has the option of incorporating videos created by other sources or educators that can be found online.

### CROSS REFERENCE TO RELATED APPLICATIONS

This application claims priority to U.S. Provisional Patent Application Ser. No. 61/452,713 filed Mar. 15, 2011, which is hereby incorporated by reference in its entirety.

### FIELD

The present disclosure relates to educational systems, more particularly, to an e-learning content management and delivery system which allows the educator to create video-based online lessons along with formative and summative assessment items.

### BACKGROUND OF THE DISCLOSURE

Online education is a relatively new field, and the technology to create online learning material is an emerging science. Teachers are currently not easily able to create a video-based online lesson for their students, employing their own content.

Conventional e-learning systems provide students with the ability to receive online instruction. Some of these e-learning systems provide web apps that provide video instruction, but none that allow an instructor to effectively/efficiently re-create the “classroom” experience.

In some conventional systems, videos and questions are all created by one user/designer and other users cannot input their own videos and content. Furthermore, there is no way for an instructor to make a self-paced, direct instruction video-based lesson with formative and summative assessment questions/items, based on their own content and receive live feedback on student performance.

Although various educational systems are known in the art, all of them suffer from one or more disadvantages. Therefore a need has arisen for a system and method for allowing educators and facilitators to easily create full lessons with pre-recorded or easily available content and assessment tools pertaining to the content which corrects the problems identified above.

### SUMMARY OF THE DISCLOSURE

The following disclosure presents concepts for improving delivery of educational content. The design of the content delivery system is based on best practices in classroom instruction, transferred into an online learning format. The lesson format includes short bursts of video-based instruction, interrupted by formative assessment in the form of multiple choice and multiple answer questions, in the same way a teacher would teach in a classroom.

In a traditional classroom direct instruction setting, the teacher explains part of an overall concept, and then asks the class questions to check their progress and understanding before moving along. This content delivery system mimics this classroom instructional model by allowing educators to import their own direct instruction content in the form of videos and add in their own questions and answer choices throughout the lesson, where appropriate.

The educator is also able to create his or her own summative assessment question items that incorporate material from multiple lessons. Using the present disclosure, the educator also has the option of incorporating videos created by other sources or educators that can be found online.

This online content delivery and management system employs a lesson builder which allows the user to incorporate his or her own videos, write his or her own assessment items, decide how many assessment items to include in the lesson and decide where and in what order those items should be included. The lesson builder also provides options for the user/teacher to decide which type of assessment items to include.

As students complete the self-paced lessons, the system provides teachers with live feedback on student performance, both percentage of completion of assigned lessons and performance. The student detail page shows student performance on assigned lessons as compared to his or her class average.

The system includes the following features: videos from multiple hosting sites; ability to add questions and type in own content; ability to choose question type, multiple choice or multiple answer (and other question types including matching and drag and drop ordering, short answer, discussion, fill in the blank); ability to add per answer option feedback; ability to drag and drop video and question boxes to arrange on lesson builder page; ability to drag and drop individual answer choices underneath questions within question box; ability to edit all lesson components (video and question display order, editing text questions, answer choices and feedback, editing question type, adding and deleting videos and questions and answer choices) as lesson is being created, on one screen. A key feature of the system is the user interface on the lesson builder. The instructor can add, edit, and delete all aspects of her lesson including videos, questions, answer choices, and feedback, in one on-the-fly editing tool, which utilizes such JavaScript features as drag and drop ordering and sorting, and Ajax for content creation and deletion. Instead of viewing one piece of the lesson at a time, the teacher sees her entire lesson plan, laid out and easily viewable and editable on one page.

Other features include the following: Student Dashboard—List of lessons assigned and completed with completion performance indicated; Teacher Dashboard—List of lesson created, recent lessons, unfinished assignments, billing if not associated with a particular school; School Dashboard—Billing; and Student Interface—Student sees a video and then subsequently view the questions associated with that video in a distraction-free mobile window. After answering each question student is shown a screen with the correct answer/s indicated and is shown any feedback that the teacher has left for that particular answer choice. Teachers can decide to randomize answer choice order to maintain individual student privacy and decrease instances of cheating if students are seated near each other. Student can view lesson afterward with grading and answer choice feedback. The system also provides a Student Data Chart—performance chart that compares current individual student scores to the class average for each assignment.

In one embodiment, an implementer could include a video recorder or video uploader. The lesson builder may be designed such that each video and question is shown one screen at a time, instead of the teacher seeing the entire lesson on one page. The system also includes the ability to upload media other than video.

According to another embodiment, the system comprises an optional lesson timer. With this optional feature, an instructor can choose to include a timer for each lesson. The educator can also choose how much time the student has to complete the lesson. Further, according to another aspect of the system, one or more of an instructor, a user, and/or a client can add optional specific feedback for each answer choice, both correct and incorrect. The educator/teacher can choose which answer choices to add specific feedback to. Such feedback can be positive reinforcement for correct answer choices or be utilized as an extra, individualized teaching opportunity to clear up a particular misconception related to that particular answer choice, if the answer is incorrect. Further, one or more of the instructor, user and/or client can create his/her own nomenclature for ‘teachers’, ‘classes’, ‘students’, and ‘assignments’ tabs in the teacher view.

Yet another embodiment provides for lesson sharing within the system. With the lesson sharing functionality, user-created lessons can be hosted on the system's server in a library. These lessons can then be, by default, searchable and shared with other users. Depending on membership level, clients can also choose to have their lessons be private and not shared with other users. Implementation of this feature can be important with corporate usage of the system, where information is desired to be confidential (i.e., not shared).

It is to be understood that both the foregoing general description and the following detailed description are exemplary and explanatory only and are not restrictive of the disclosure, as claimed. The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

The above as well as additional objectives, features, and advantages of the present invention will become apparent in the following detailed written description.

### BRIEF DESCRIPTION OF THE DRAWINGS

The accompanying drawings, which are incorporated in and constitute a part of this specification, illustrate embodiments of the disclosure and together with the description, serve to explain the principles of the disclosure.

FIG. 1 illustrates an exemplary system for employing the novel aspects of the presently disclosed online learning content management and delivery system.

FIG. 2 is an example user interface illustrating components/features of a lesson provided by the system which shows a specific arrangement of lesson components for ordered execution of content based on user specification, according to one embodiment;

FIG. 3 is an illustration of various types of question formats that may be selected by the designer/teacher to be integrated within the assessment segment of a lesson supported by the system, according to one embodiment;

FIG. 4 is an illustration of an example user interface for the interactive assessment segment, the answers provided by a student, and the results based on the student's response, according to one embodiment;

FIG. 5 is a database schematic that illustrates how question blocks are stored in the database, according to one embodiment;

FIG. 6 is an illustration of the connections and dependencies between functional blocks/components within the system, according to one embodiment;

FIG. 7 is an illustration of a multiple correct answer scoring and grading matrix, according to one embodiment;

FIG. 8 is an illustration of a single correct answer scoring and grading matrix, according to one embodiment;

FIG. 9 is an illustration establishing a logical schematic for assignments being independent of classes within the system, according to one embodiment;

FIG. 10 is an illustration of record of attempts by a student to correctly answer particular questions in the test segment, according to one embodiment;

FIG. 11 is an illustration of a webpage that enables a teacher to view/edit various components of his/her lessons, classes and assignments, according to one embodiment;

FIG. 12 is an illustration of another record of attempts by a student to correctly answer particular questions in the test segment, according to one embodiment;

FIG. 13 is an illustration of a webpage that enables an instructor to login and view/edit student information, according to one embodiment;

FIG. 14 is an illustration of calculations related to multiple correct answer matrix for the tracking of a student's performance, according to one embodiment;

FIG. 15 is an illustration of a user interface provided by the system that enables the teacher to select and assign lessons to particular classes/students, according to one embodiment;

FIG. 16 is an illustration of a database schematic for lessons being assigned to students and belonging to instructors, according to one embodiment;

FIG. 17 is an illustration of an example promotional webpage for the system, according to one embodiment;

FIG. 18 is an illustration of an example homepage for the system, according to one embodiment;

FIG. 19 is an illustration of a portion of the planning log/record/notes of the designers and creators of the system, according to one embodiment;

FIG. 20 is an illustration of a process flow that enables a user to utilize various features of the system, according to one embodiment;

FIG. 21 shows information and links being displayed within an example teacher dashboard, according to one embodiment;

FIG. 22 shows historical information about lessons and assignment of lessons, according to one embodiment;

FIG. 23 is an illustration of a lesson with integrated video content and a question/assessment segment, according to one embodiment;

FIG. 24 shows a list of information about teachers and the respective classes, according to one embodiment;

FIG. 25 shows teacher information and that user/client can create their own nomenclature for teachers, classes, students, and assignments, according to one embodiment;

FIG. 26 is an illustration of a display showing lesson archive information from all participating instructors/clients, allowing lesson sharing between users/clients, according to one embodiment;

FIG. 27 shows information about assignments, links to enable a teacher to edit current assignments and links to enable the teacher to make new assignments, according to one embodiment;

FIG. 28 illustrates a webpage by which a teacher is able to make edits to an existing assignment, according to one embodiment;

FIG. 29 shows information about classes supported by the system and a link to enable the teacher to create new classes, according to one embodiment;

FIG. 30 illustrates a webpage by which a teacher is able to add/remove students to/from particular classes, according to one embodiment;

FIG. 31 shows student information for a particular teacher, according to one embodiment;

FIG. 32 illustrates a webpage by which a teacher is able to add a new student, according to one embodiment;

FIG. 33 shows information comprising individual student performance graph as compared to class average, t assignment completion and performance by a particular student, and ability to edit student information, according to one embodiment;

FIG. 34 shows information about lesson assignment for a particular student, according to one embodiment.

### DETAILED DESCRIPTION OF THE DISCLOSURE

Reference will now be made in detail to the present embodiments of the disclosure, examples of which are illustrated in the accompanying drawings. Wherever possible, the same reference numbers will be used throughout the drawings to refer to the same or like parts of elements.

To help understand the advantages of this disclosure the accompanying drawings will be described with additional specificity and detail.

The described embodiments provide a method, system and computer program product for enabling creation of online lessons by a facilitator/instructor 1700 and providing the online lessons to a participant 1702. The embodiments further provides a lesson builder by which the facilitator 1700 is able to place various types of content including video access content on a webpage. Aspects of the described embodiments enable the facilitator 1700 to arrange placement of content on the webpage in order to subsequently provide a participant 1702 with an ordered access to the content according to placement arranged for the content.

By employing the lesson builder, the instructor can add, edit, and delete all aspects of the lesson including videos in one on-the-fly editing tool, which utilizes such JavaScript features as drag and drop ordering and sorting, and Ajax for content creation and deletion. Instead of viewing one piece of the lesson at a time, the instructor views the entire lesson plan, laid out and easily viewable and editable on one page. The embodiments further provide the capability for integration of video access content from multiple hosting sites. The embodiments also enable the facilitator 1700 to include a test segment within the lesson. During execution of the online lesson by the participant 1702, the invention provides participant assessment within a test segment. One or more embodiments of system receive participant responses during execution of the test segment. In one or more embodiments, the system evaluates test performance of the participant 1702 and provides a (live feedback) report about lesson and test performance of the participant 1702 to the facilitator 1700. Embodiments of the invention provide feedback to the participant 1702 based on lesson and test performance. In addition, one or more embodiments maintain historical records of information about lesson completion by participants 1702.

In the following detailed description of exemplary embodiments of the invention, specific exemplary embodiments in which the invention may be practiced are described in sufficient detail to enable those skilled in the relevant technology to practice the invention, and it is to be understood that other embodiments may be used and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

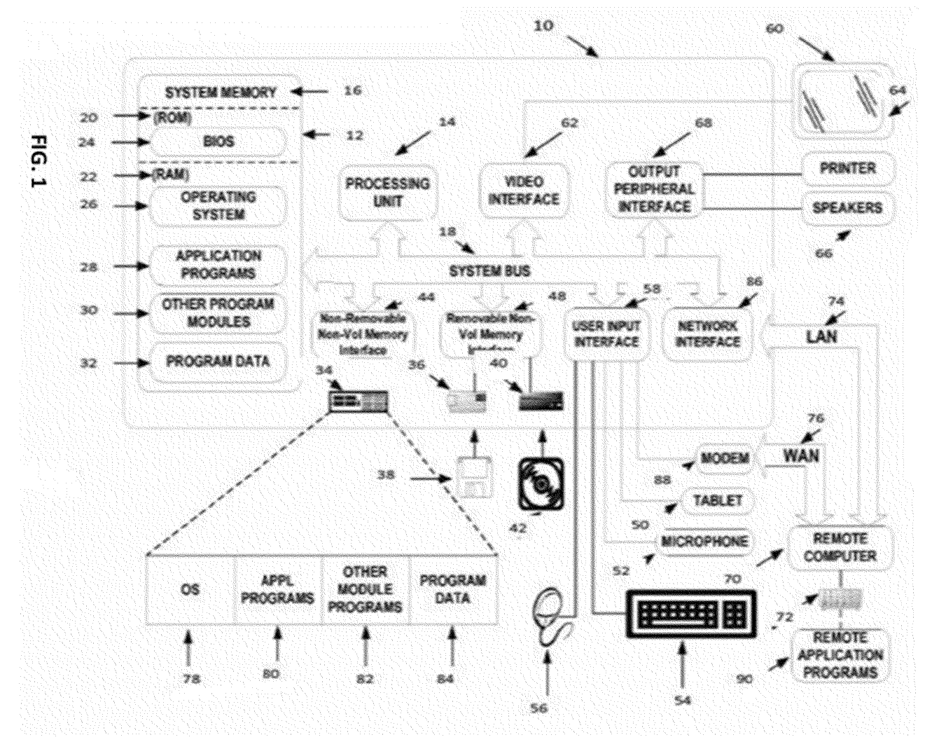

FIG. 1 illustrates an exemplary system within a computing environment for implementing the system of the present disclosure and which includes a general purpose computing device in the form of a computing system 10, commercially available from Intel, IBM, AMD, Motorola, Cyrix and others. Components of the computing system 10 may include, but are not limited to, a processing unit 14, a system memory 16, and a system bus 46 that couples various system components including the system memory to the processing unit 14. The system bus 46 may be any of several types of bus structures including a memory bus or memory controller, a peripheral bus, and a local bus using any of a variety of bus architectures.

Computing system 10 typically includes a variety of computer readable media. Computer readable media may be any available media that may be accessed by the computing system 10 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data.

Computer memory includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computing system 10.

The system memory 16 includes computer storage media in the form of volatile and/or nonvolatile memory such as read only memory (ROM) 20 and random access memory (RAM) 22. A basic input/output system 24 (BIOS), containing the basic routines that help to transfer information between elements within computing system 10, such as during start-up, is typically stored in ROM 20. RAM 22 typically contains data and/or program modules that are immediately accessible to and/or presently being operated on by processing unit 14. By way of example, and not limitation, FIG. 1 illustrates operating system 26, application programs 30, other program modules 30 and program data 32.

Computing system 10 may also include other removable/non-removable, volatile/nonvolatile computer storage media. By way of example only, the drawing illustrates a hard disk drive 34 that reads from or writes to non-removable, nonvolatile magnetic media, a magnetic disk drive 36 that reads from or writes to a removable, nonvolatile magnetic disk 38, and an optical disk drive 40 that reads from or writes to a removable, nonvolatile optical disk 42 such as a CD ROM or other optical media.

Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 34 is typically connected to the system bus 46 through a non-removable memory interface such as interface 44, and magnetic disk drive 36 and optical disk drive 40 are typically connected to the system bus 46 by a removable memory interface, such as interface 48.

The drives and their associated computer storage media, discussed above and illustrated in FIG. 1, provide storage of computer readable instructions, data structures, program modules and other data for the computing system 10. In FIG. 1, for example, hard disk drive 34 is illustrated as storing operating system 78, application programs 80, other program modules 82 and program data 84. Note that these components may either be the same as or different from operating system 26, application programs 30, other program modules 30, and program data 32. Operating system 78, application programs 80, other program modules 82, and program data 84 are given different numbers hereto illustrates that, at a minimum, they are different copies.

A user may enter commands and information into the computing system 10 through input devices such as a tablet, or electronic digitizer, 50, a microphone 52, a keyboard 54, and pointing device 56, commonly referred to as a mouse, trackball, or touch pad. These and other input devices are often connected to the processing unit 14 through a user input interface 58 that is coupled to the system bus 18, but may be connected by other interface and bus structures, such as a parallel port, game port or a universal serial bus (USB).

A monitor 60 or other type of display device is also connected to the system bus 18 via an interface, such as a video interface 62. The monitor 60 may also be integrated with a touch-screen panel or the like. Note that the monitor and/or touch screen panel may be physically coupled to a housing in which the computing system 10 is incorporated, such as in a tablet-type personal computer. In addition, computers such as the computing system 10 may also include other peripheral output devices such as speakers 64 and printer 66, which may be connected through an output peripheral interface 68 or the like.

Computing system 10 may operate in a networked environment using logical connections to one or more remote computers, such as a remote computing system 70. The remote computing system 70 may be a personal computer, a server, a router, a network PC, a peer device or other common network node, and typically includes many or all of the elements described above relative to the computing system 10, although only a memory storage device 72 has been illustrated in FIG. 1. The logical connections depicted in FIG. 1 include a local area network (LAN) 74 connecting through network interface 86 and a wide area network (WAN) 76 connecting via modem 88, but may also include other networks. Such networking environments are commonplace in offices, enterprise-wide computer networks, intranets and the Internet.

For example, in the present embodiment, the computer system 10 may comprise the source machine from which data is being migrated, and the remote computing system 70 may comprise the destination machine. Note however that source and destination machines need not be connected by a network or any other means, but instead, data may be migrated via any media capable of being written by the source platform and read by the destination platform or platforms.

The central processor operating system or systems may reside at a central location or distributed locations (i.e., mirrored or stand-alone). Software programs or modules instruct the operating systems to perform tasks such as, but not limited to, facilitating client requests, system maintenance, security, data storage, data backup, data mining, document/report generation and algorithms. The provided functionality may be embodied directly in hardware, in a software module executed by a processor or in any combination of the two.

Furthermore, software operations may be executed, in part or wholly, by one or more servers or a client's system, via hardware, software module or any combination of the two. A software module (program or executable) may reside in RAM memory, flash memory, ROM memory, EPROM memory, EEPROM memory, registers, hard disk, a removable disk, a CD-ROM, DVD, optical disk or any other form of storage medium known in the art. An exemplary storage medium is coupled to the processor such that the processor may read information from, and write information to, the storage medium. In the alternative, the storage medium may be integral to the processor. The processor and the storage medium may also reside in an ASIC. The bus may be an optical or conventional bus operating pursuant to various protocols that are well known in the art. A recommended system may include a Linux workstation configuration with a Linux 64-bit or 32-bit Red Hat Linux WS3 operating system, and an NVIDIA Quadro graphics card. However, the disclosed system may operate on a wide variety of Linux PC hardware, ranging from custom-built desktops to leading laptop vendors.

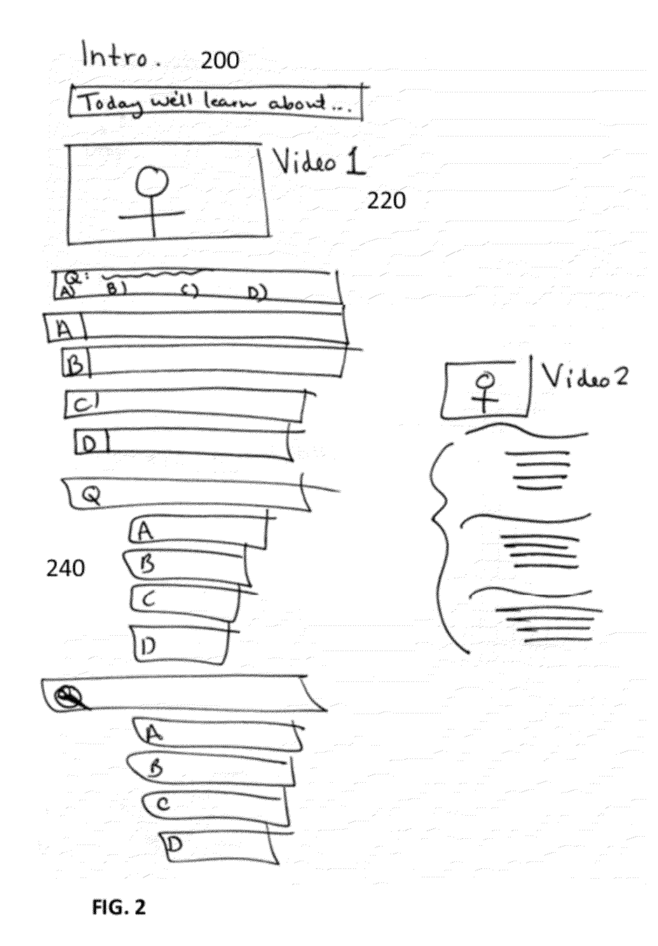

FIG. 2 is an exemplary user interface illustrating components of a lesson provided by the education system and lesson builder module which shows a specific arrangement of lesson components for ordered execution of content based on user specification. The system allows a teacher or trainer to take a lesson plan intended for the classroom setting and put in a video-based e-learning format. For example, in a traditional classroom setting, if a secondary science teacher, Mrs. Garcia, were teaching about types of rocks, then she might first explain to the class how sedimentary rocks are formed. The teacher/instructor would then ask the class questions to make sure that they understood the basics of sedimentary rock formation before moving on to igneous rocks. The instructor would then check for understanding about igneous rocks before moving onto metamorphic rocks. The instructor would teach this same lesson to multiple classes throughout the day, up to 8 times, repeating the same lectures and same questions.

By employing the teachings of the present disclosure, Mrs. Garcia could plan her lesson the day before and video record herself teaching each of her lesson portions. She would then upload those videos to YouTube, schooltube, or teachertube. Using the present disclosure, she can create a lesson around these videos, embedding each video into the lesson in whatever chronological way she chooses and adding questions associated with the content of each video and the specific state objectives that her students are required to master. She can also choose to embed via the system any other videos on the topic that she feels transfer the objectives in a meaningful way for her students.

The teacher layout makes it easy for Mrs. Garcia to see the flow of her lesson. The question fields are listed below the video that they are associated with. For each question, the instructor is allowed to choose the question type, to choose whether the question has multiple correct answers or just one, to write out the question as the instructor wants the question written, and to write and add as many or as few answer choices as the instructor wishes.

The system also allows the instructor to add specific feedback regarding each answer choice that the student will receive as he or she chooses an answer. For example, if the question is, “Which type of rock would most likely be formed in a river bed?” and the student chooses the answer choice, “Igneous”, Mrs. Garcia can have her own specific feedback show on screen that says, “Remember, igneous rock are formed from the lava from volcanoes. So, it is unlikely that an igneous rock would be formed in a river bed.” Mrs. Garcia can choose to add specific feedback to any answer choice or to leave it off altogether. As Mrs. Garcia plans out her lesson, the lesson builder provides the capability to enable all represented elements to be easily moved by dragging.

The lesson builder allows the instructor to be able to choose to add or delete questions or videos, and the instructor is also able to change the order of any or all of these elements by dragging. Each video and each question is housed in its own user-friendly dragable box on screen. This enables the facilitator (teacher and/or designer) 1700 to specify content blocks 200, and allows student and teacher inputs based on the various types of interaction formats and further provides an assessment segment 240, according to one embodiment.

The lesson builder is designed with usability in mind. Teachers can choose to add any number of videos from a myriad of video hosting sites, such as YouTube, teachertube, or schooltube. Teacher can also write questions to formatively assess students' knowledge after watching each video. The teacher can add any number of questions associated with each video. To arrange videos and questions on the lesson page in a certain order, teachers just drag and drop the box containing the video or question to the position they would like it to be in as they are writing the lesson. When the teacher adds a question, the teacher has several choices pertaining to that question. The teacher can choose whether the question is multiple choice or multiple answer, and the order in which the answers appear. The teacher enters her own text for the question-and-answer choices, and can also choose to add specific feedback to be displayed to the student based on the answer that he or she chooses. The teacher decides how many videos, questions and answer choices for each question are contained within one lesson.

The lesson format includes short bursts of video-based instruction, interrupted by formative assessment in the form of multiple choice and multiple answer questions, in the same way a teacher would teach in a classroom. The instructor can choose to add specific feedback to any answer choice or to leave it off altogether. As the instructor plans out the lesson, all represented elements are easily moved by dragging. The instructor can choose to add or delete questions or videos, and can change the order of any or all of these elements by dragging. Each video and each question is housed in its own user-friendly dragable box on screen.

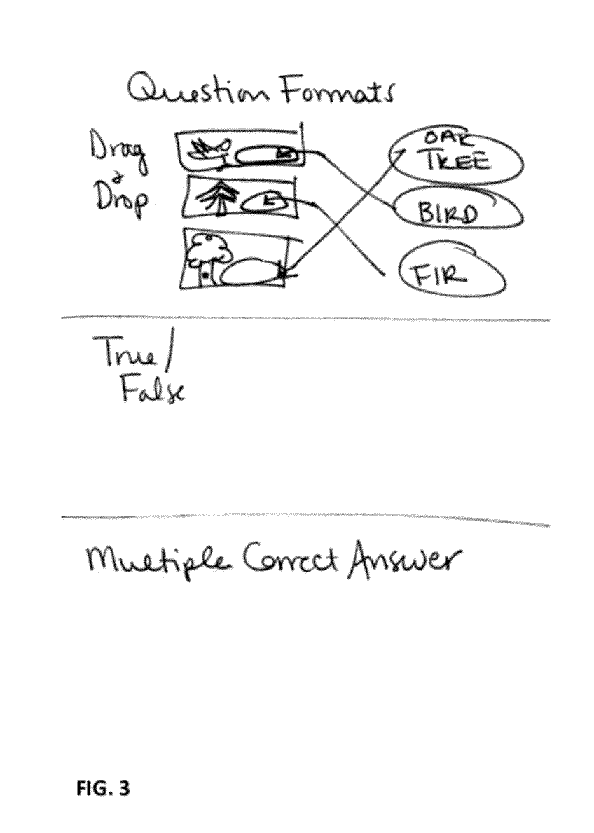

FIG. 3 is an illustration of various types of question formats in the assessment segment 240 that may be selected by the designer/teacher to be integrated within test segment of a lesson supported by the system, according to one embodiment. Some exemplary question formats include, but is not limited to: brainteasers, interactive diagrams, flash cards, jigsaw puzzles, classification exercises, analogous pairs, surveys, multiple-choice answers, fill-in-the-blank, free form text, etc. The question fields within the test segment may be listed below a video with which they may be associated. For each question, the instructor can choose the question type, choose whether it has multiple correct answers or just one, write out the question as he/she wants it written, and write and add as many or as few answer choices as he/she wishes.

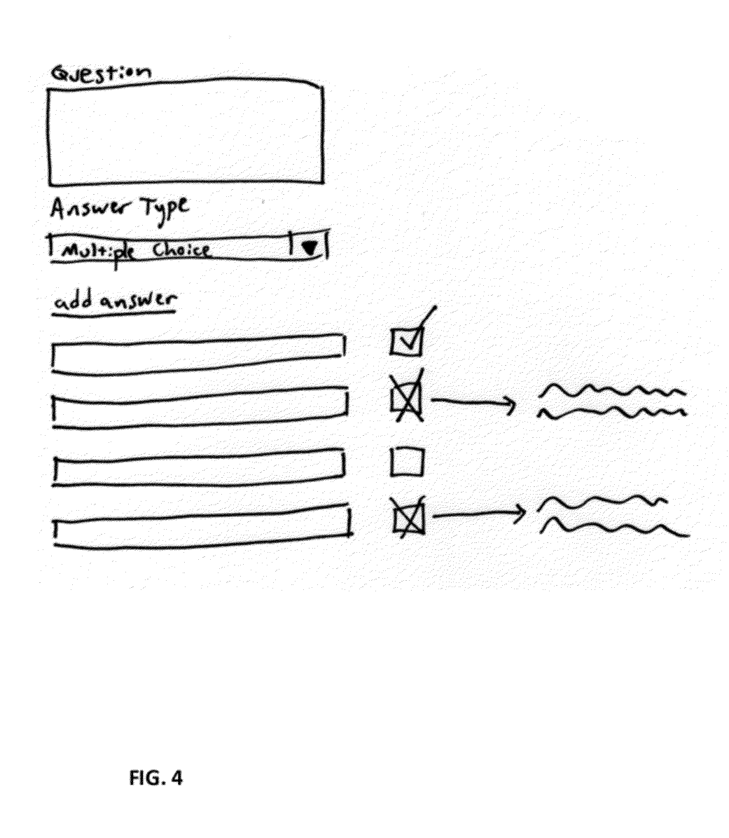

FIG. 4 is an illustration of an example user interface for the interactive test segment, the answers provided by a student and the results based on the student's response, according to one embodiment. As students complete the (self-paced) lessons, teachers receive (live) feedback on student performance, both percentage of completion of assigned lessons and performance. In one embodiment, the system may dynamically determine the subsequent segments of the lesson based on the results of a student's performance. For example, when a student has a poor performance in understanding certain concepts of the lesson, the system may provide additional content for review of fundamental concepts as well as encouraging the student to review previously accessed/viewed content associated with the test.

The system allows a teacher to provide feedback to a student based on responses to specific questions. For example, if the question is, “Which type of rock would most likely be formed in a river bed?”, and the student chooses the answer choice, “Igneous”, the teacher can have his/her own specific feedback show on screen that says, “Remember, igneous rock are formed from the lava from volcanoes. So, it is unlikely that an igneous rock would be formed in a river bed.” The teacher can choose to add specific feedback to any answer choice or to leave it off altogether.

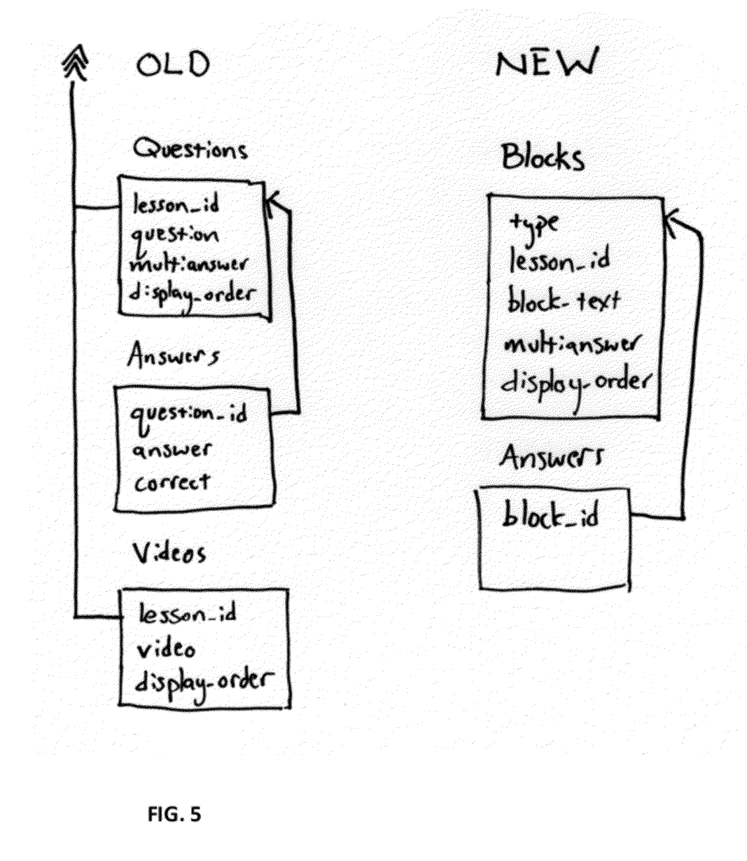

FIG. 5 is a block diagram that illustrates the simplified model used for executing a lesson plan that includes assessment segments 240, as provided by the system, according to one embodiment. In one implementation, the question segments between videos are called formative assessment items, since the segments present ‘check for understanding’ questions that happen throughout the lesson. In one embodiment, teachers can also create separate ‘tests’ that are only questions and do not include videos. Additionally, tests can be questions that test students' knowledge learned over several different lessons, and so these tests are referred to as ‘summative’ assessment items. Though formative assessment questions do technically test knowledge learned in the previous video, they are not actual ‘tests’, according to the present embodiment.

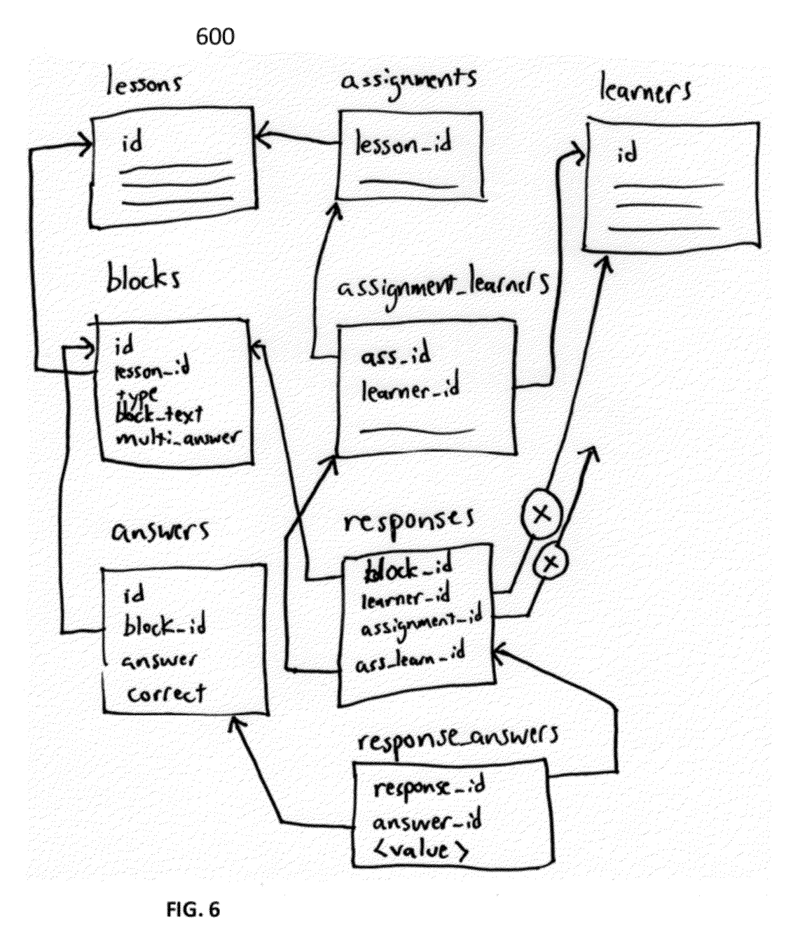

FIG. 6 is an illustration of the connections and dependencies between functional blocks/components within the system, according to one embodiment. As students complete the lesson on their own individual computers, their percent completion and percent correct data is posted for the instructor to see in immediately. The instructor can see this information on the teacher screen on his or her computer or on a tablet. Because the instructor is teaching the lesson to students via the web, he or she is free to go and help individual students who are having problems. For example, instructor might see that a student, Michael, is 80% complete but has a current score of 40% correct. The instructor could go spend some one-on-one time with Michael to address this issue and help Michael to better understand why he is not answering the questions correctly. If the instructor sees that Angie has completed her lesson early with a 100% score, he/she can allow Angie to move onto other lessons or give her an extra credit project to work on regarding the rock cycle. The system is designed to free up time for teachers and trainers so that they can spend more time with individual students as each student in the class moves at his or her own pace.

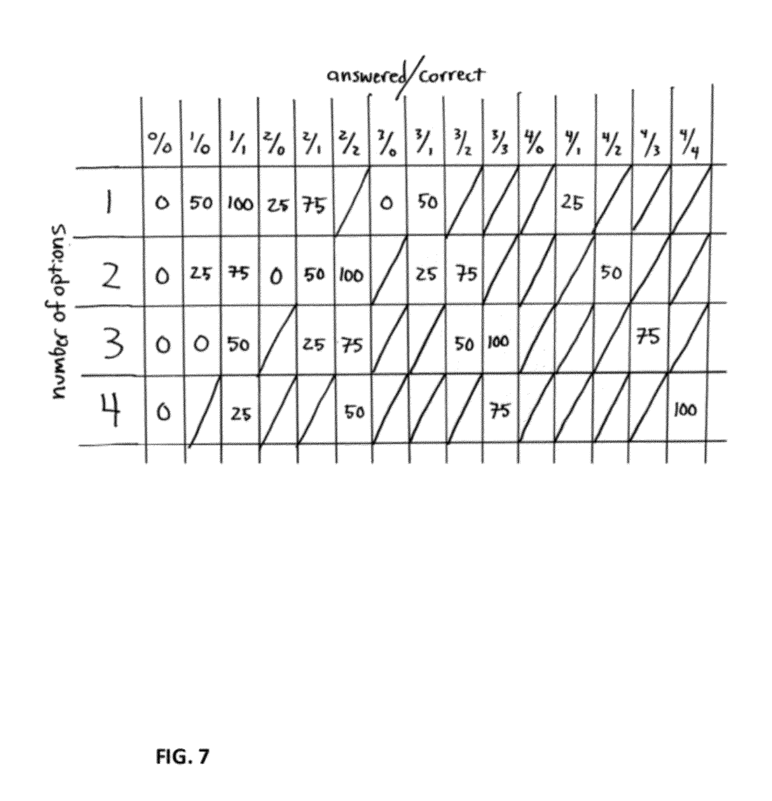

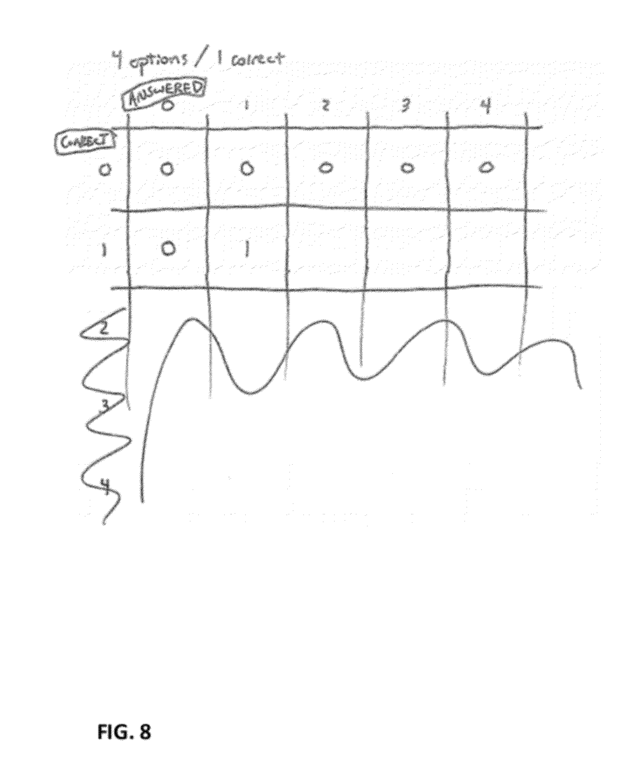

FIG. 7 is an illustration of an example chart of results from the interactive test segment, according to one embodiment. The system may similarly provide a Student Data Chart which is a performance chart that compares current individual student scores to the class average for each assignment. FIG. 8 is an illustration of a single correct answer scoring and grading matrix, according to one embodiment.

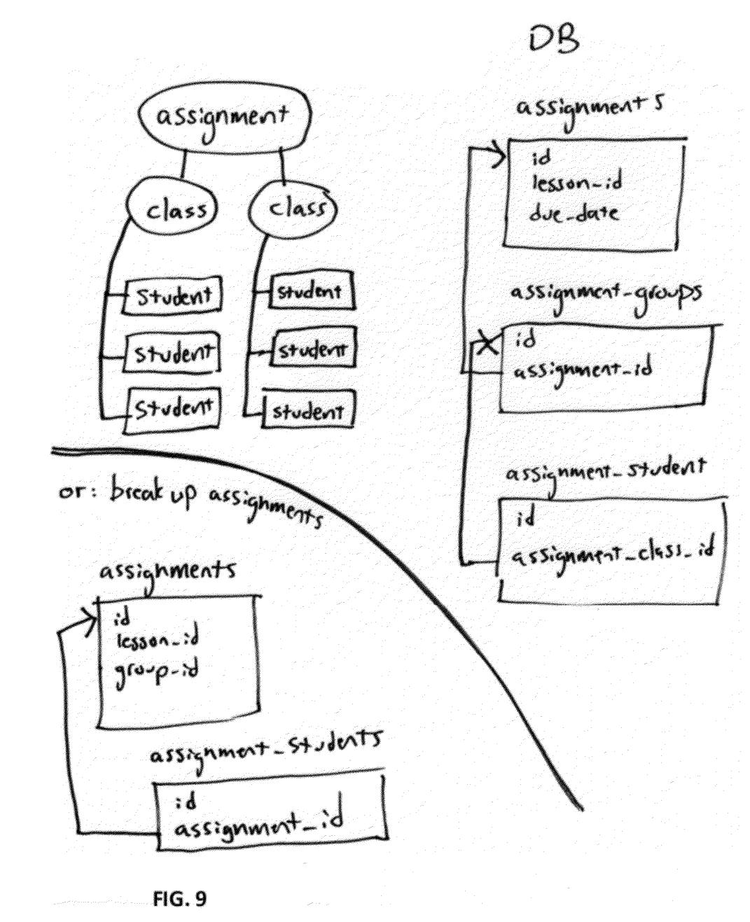

FIG. 9 is an illustration establishing a logical schematic for assignments being independent of classes within the system, according to one embodiment. For exemplary purposes, the facilitator 1700 has an option for her to assign lessons to classes within classes, or groups within classes. Meaning, if she has a 12th grade English class and half of them are higher level students and half of them are lower-level students, she can create a high-level group within that class and a lower-level group within that class. She can then make two versions of the lesson for that day—and assign the higher-level lesson to the higher group in the class and the lower-level lesson to the lower level half of the same class. Additionally, assignments and lessons are not necessarily restricted to the class for which they are initially prepared. The prepared material is portable to other classes, and may be modified for subsequent use.

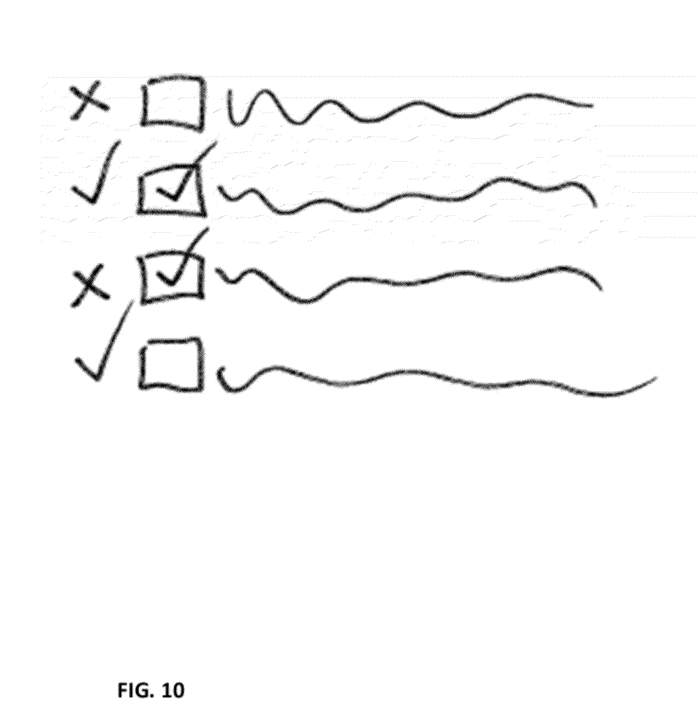

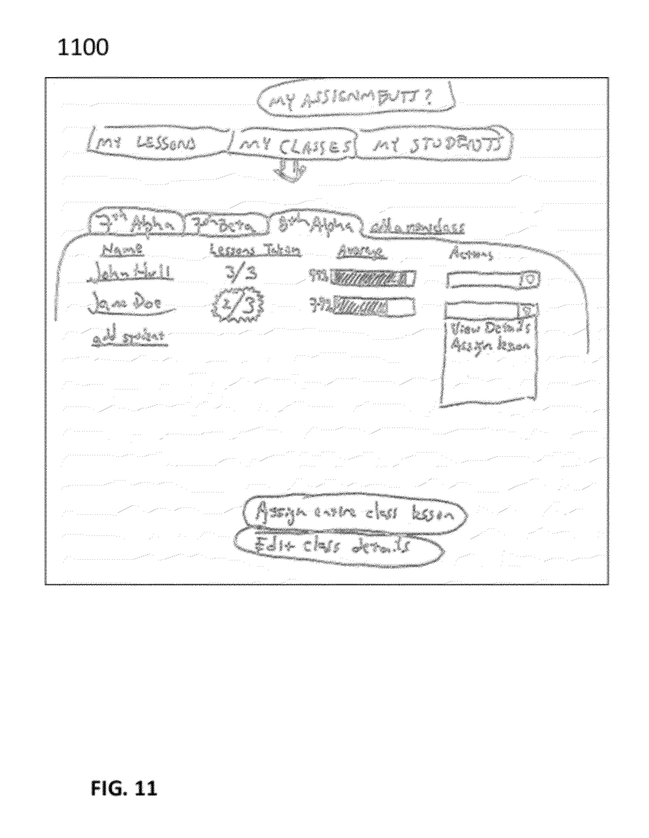

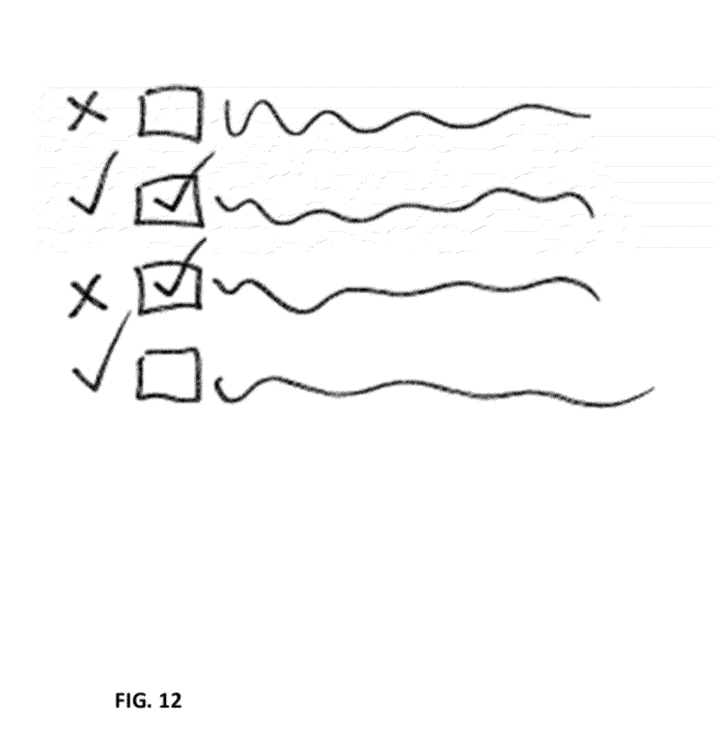

FIG. 10 is an illustration of record of attempts by a student to correctly answer particular questions in the test segment, according to one embodiment. FIG. 11 is an illustration of a webpage that enables a teacher to view/edit various components of his/her lessons, classes and assignments, according to one embodiment. FIG. 12 is an illustration of another record of attempts by a student to correctly answer particular questions in the test segment, according to one embodiment.

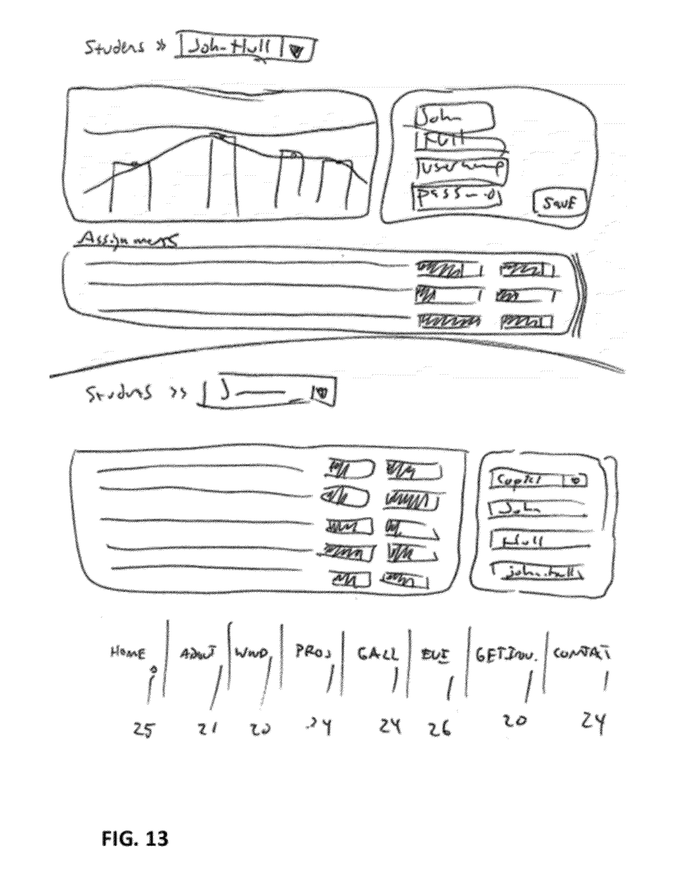

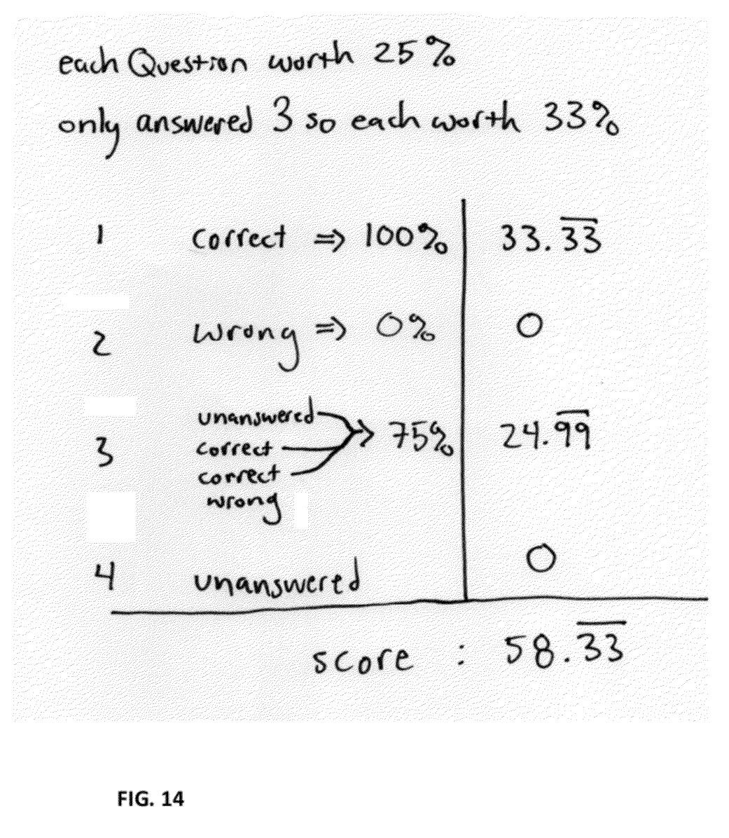

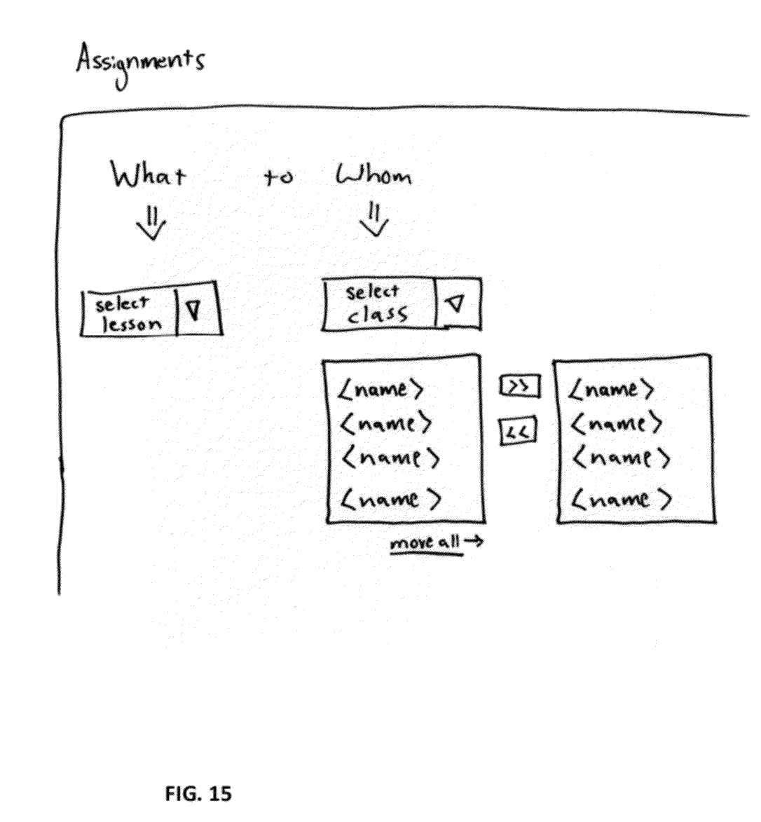

FIG. 13 is an illustration of a webpage that enables an instructor to login and view/edit student information, according to one embodiment. FIG. 14 is an illustration of calculations related to multiple correct answer matrix for the tracking of a student's performance, according to one embodiment. FIG. 15 is an illustration of a user interface provided by the system that enables the teacher to select and assign lessons to particular classes/students, according to one embodiment. As previously disclosed, the system enables the facilitator 1700 to select from a list of previously created lessons or assignments and designate any particular individual or groups to have access to the material.

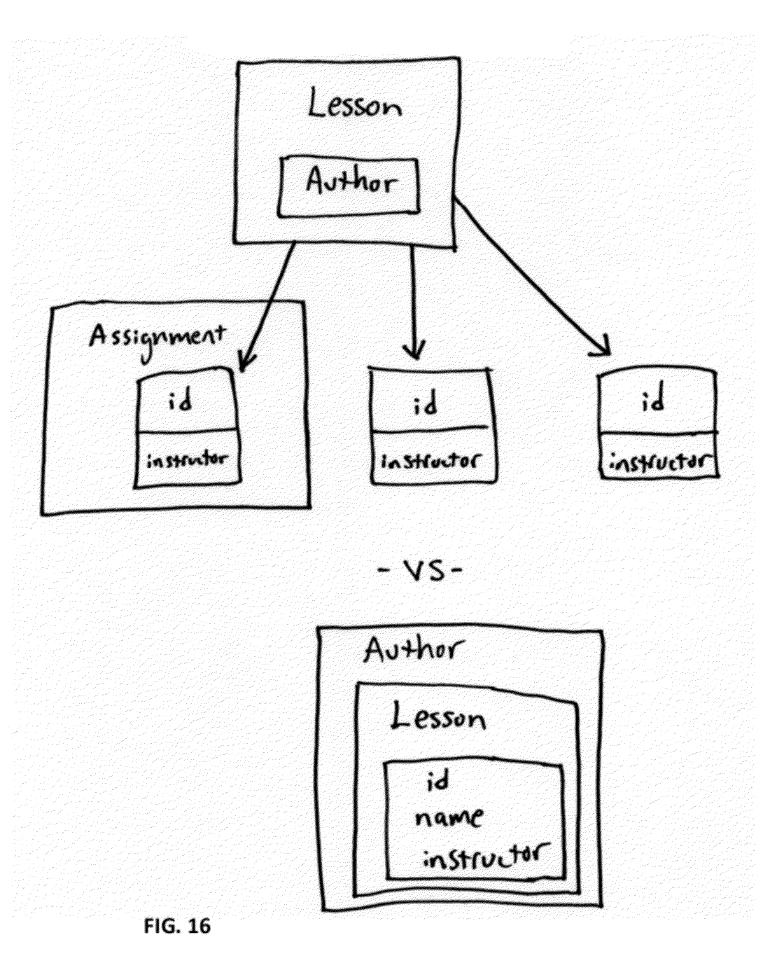

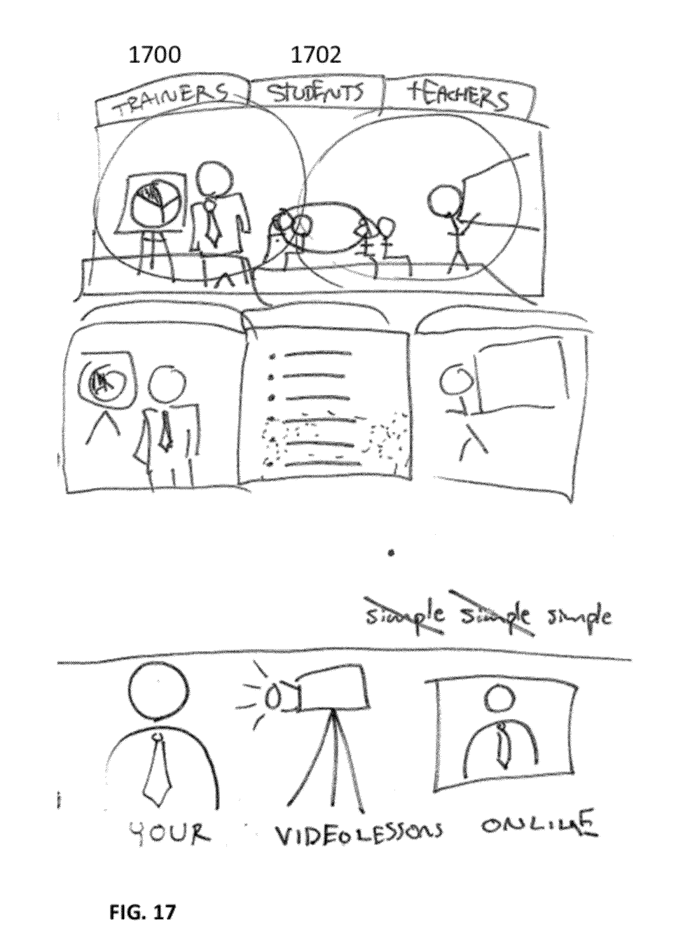

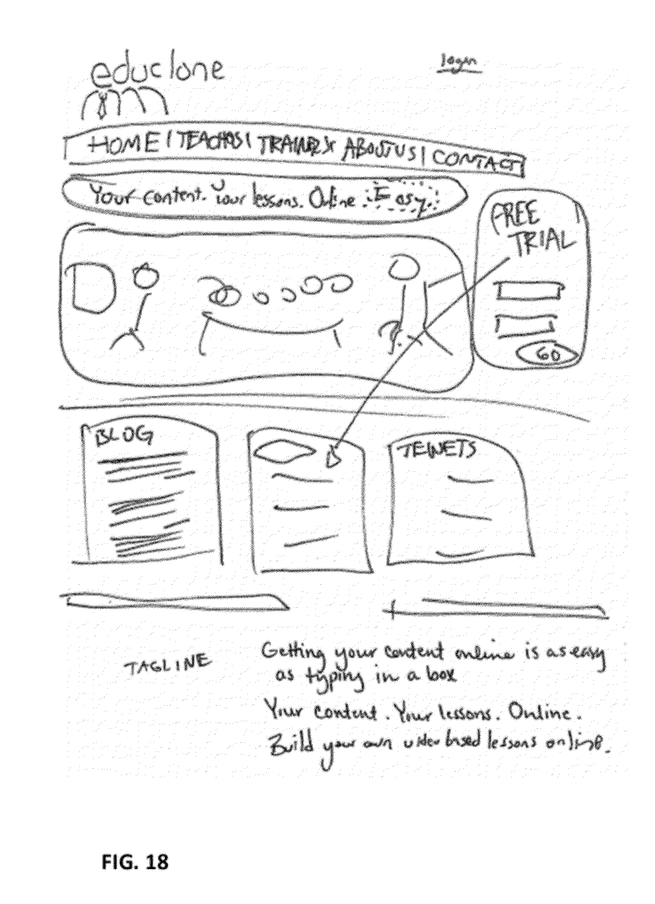

FIG. 16 is an illustration of a database schematic for lessons being assigned to students and belonging to instructors, according to one embodiment. FIG. 17 is an illustration of an example promotional webpage for the system, according to one embodiment. FIG. 18 is an illustration of an example homepage for the system, according to one embodiment.

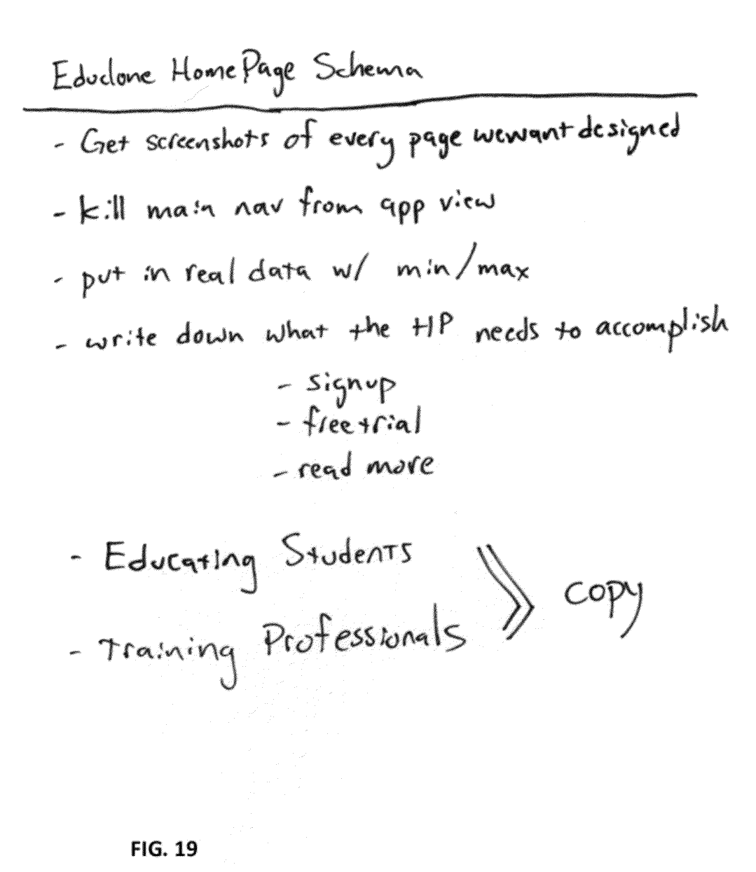

FIG. 19 is an illustration of a portion of the planning log/record/notes of the designers and creators of the system, according to one embodiment.

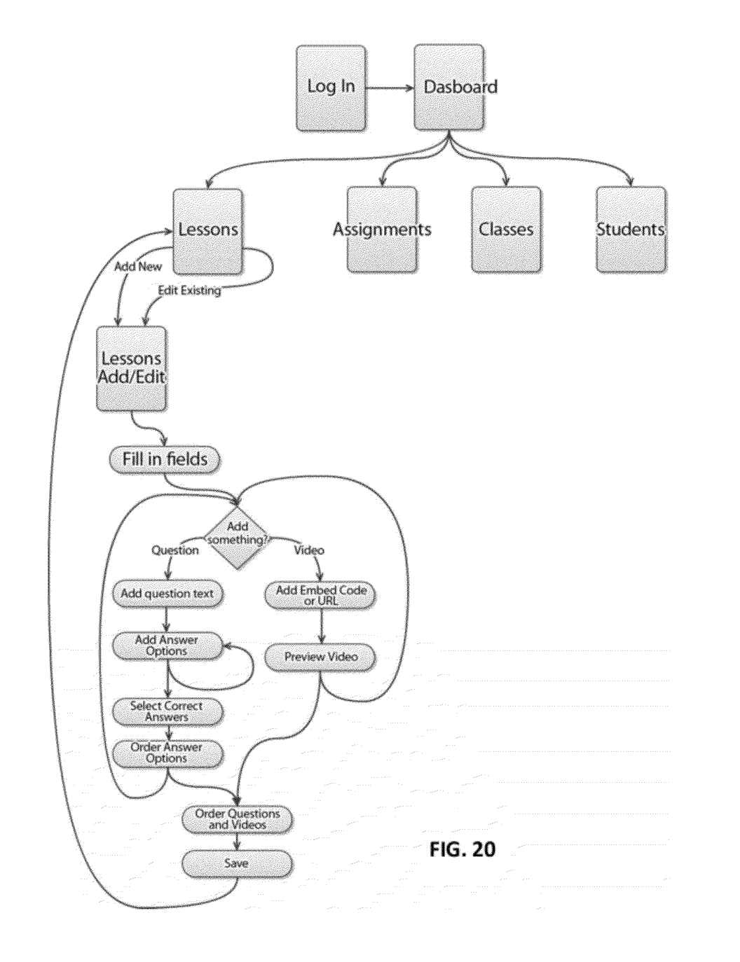

FIG. 20 is an illustration of a process flow that enables a user to utilize various features of the system, according to one embodiment.

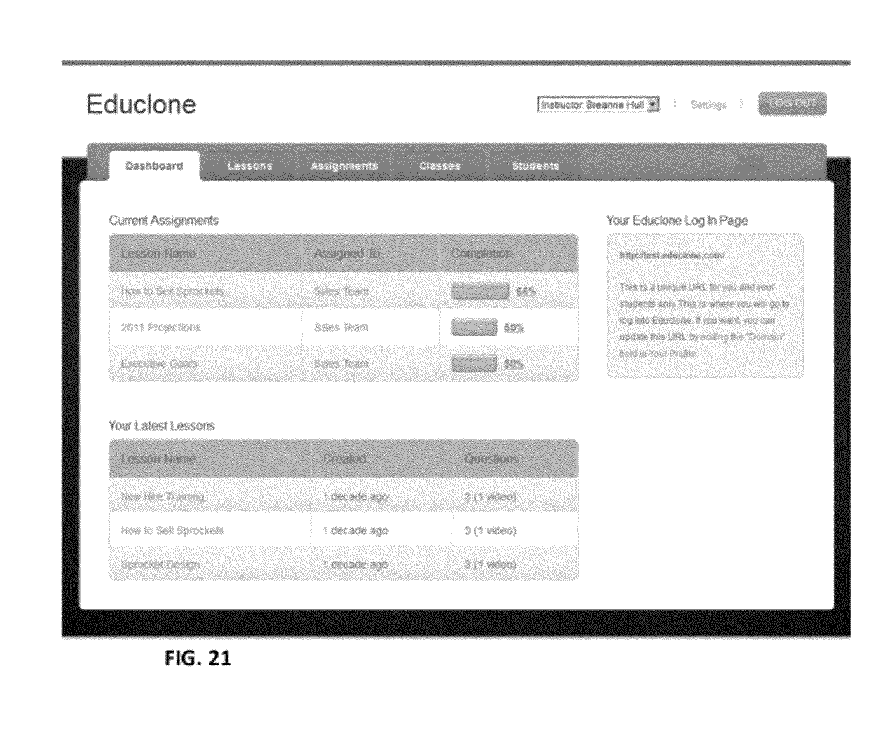

FIG. 21 shows information and links being displayed within an example teacher dashboard, according to one embodiment. This dashboard is an organized and hierarchal view of the facilitator's content and lessons within the site. Lessons that have previously been created are accessible through this dashboard. Further, currently pending assignments and which participants they have been assigned to are accessible through the dashboard. The data processing modules calculate various performance metrics, which include, but is not limited to: percent completion, performance scores, average time for completion, etc. These are viewable to the facilitator, who can in turn utilize those metrics for determining future lesson plans or may decide to act upon them immediately by engaging with students to address any learning issues.

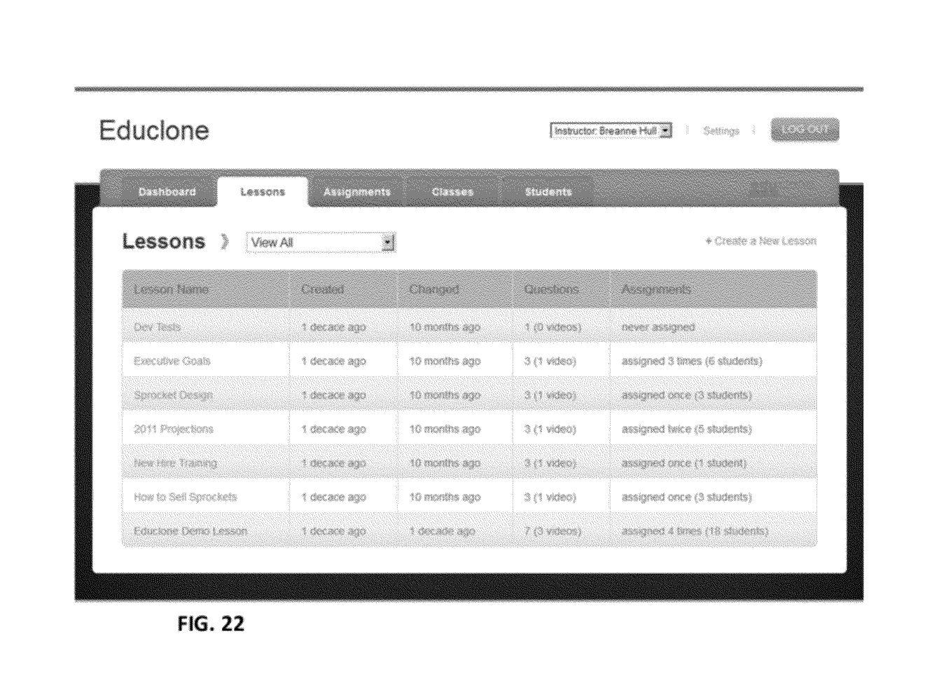

FIG. 22 shows historical information about lessons and assignment of lessons, according to one embodiment.

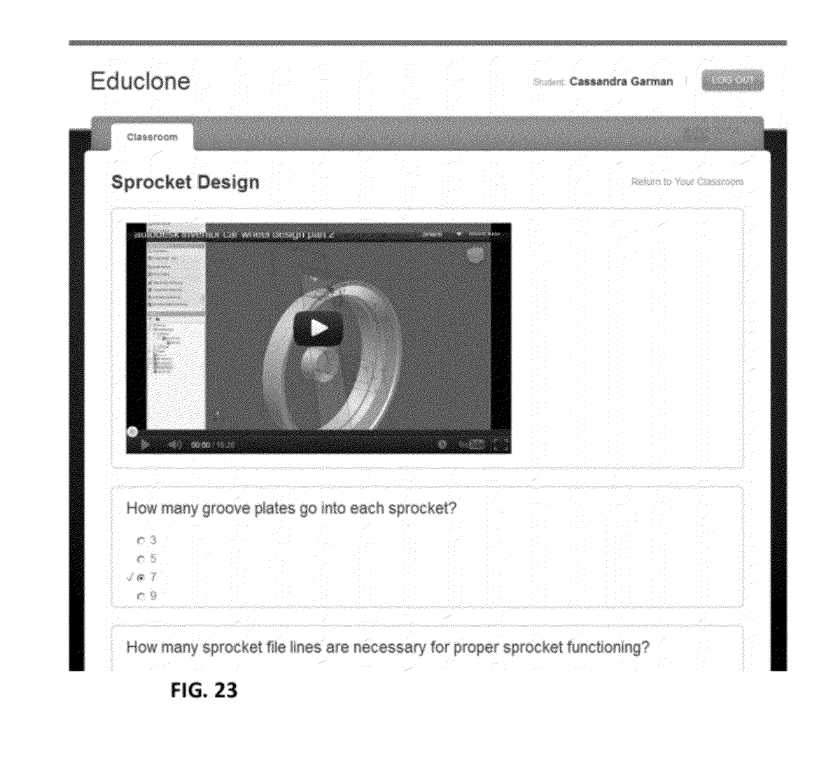

FIG. 23 is an illustration of a lesson with integrated video content and a question/test segment, according to one embodiment. Using the present disclosure, an instructor can create a lesson around these videos, embedding each video into the lesson in whatever chronological way she chooses and adding questions associated with the content of each video and the specific state objectives that her students are required to master. The instructor can also choose to embed via the system any other videos on the topic that he/she feels transfer the objectives in a meaningful way for her students. The teacher layout makes it easy for Mrs. Garcia to see the flow of her lesson.

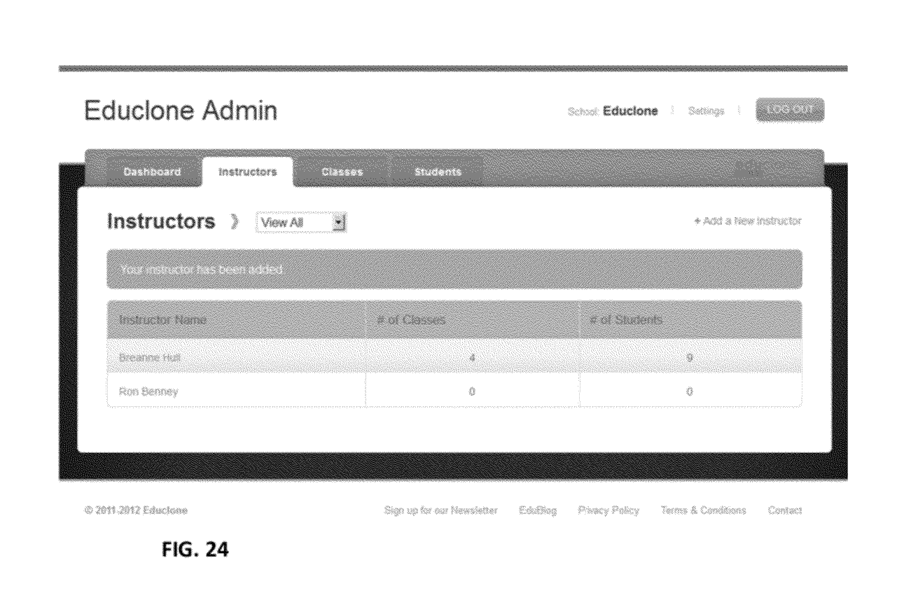

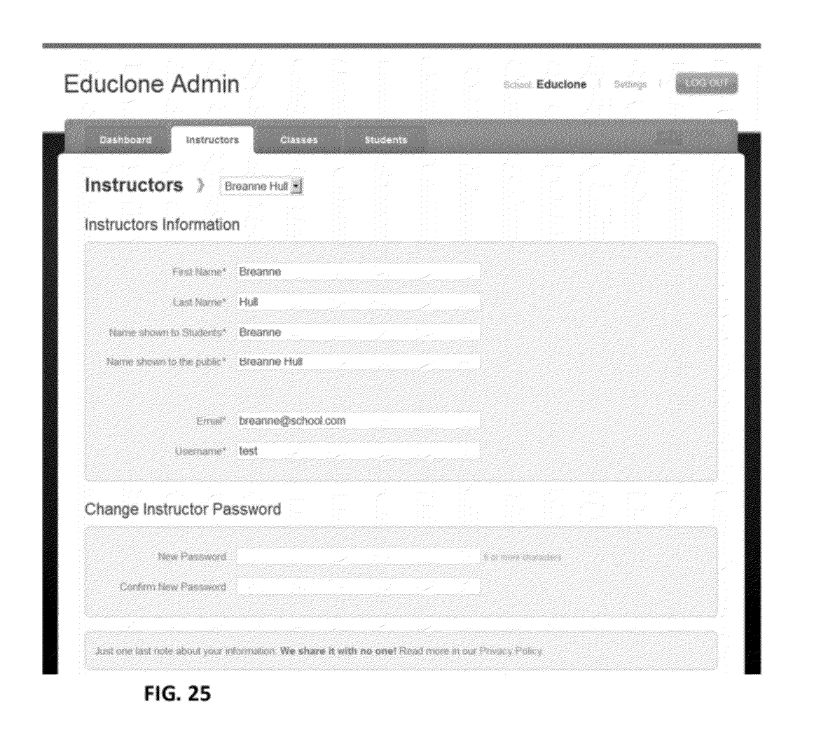

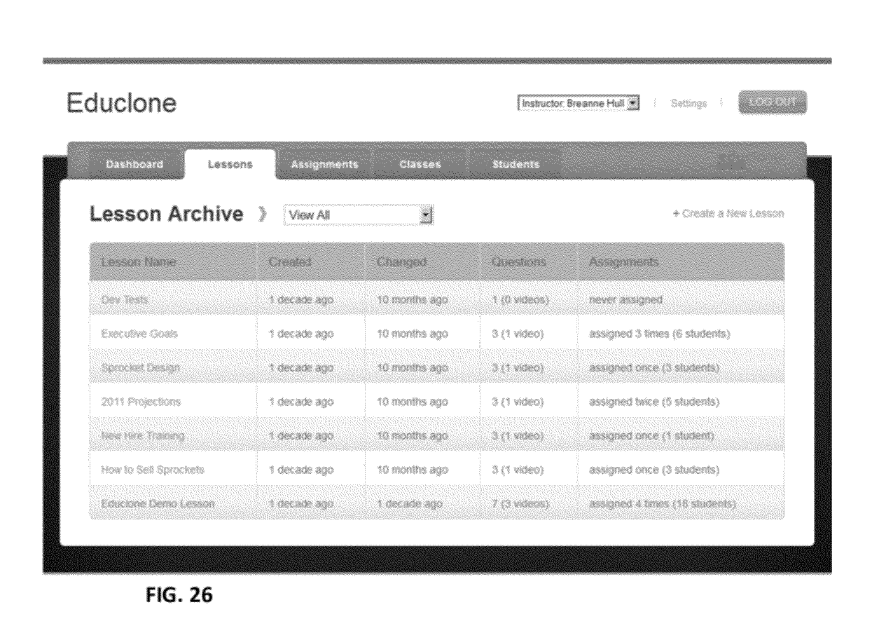

FIG. 24 shows a list of information about teachers and the respective classes, according to one embodiment. FIG. 25 shows teacher information and that user/client can create their own nomenclature for teachers, classes, students, and assignments, according to one embodiment. FIG. 26 is an illustration of a display showing lesson archive information from all participating instructors/clients, allowing lesson sharing between users and clients, according to one embodiment.

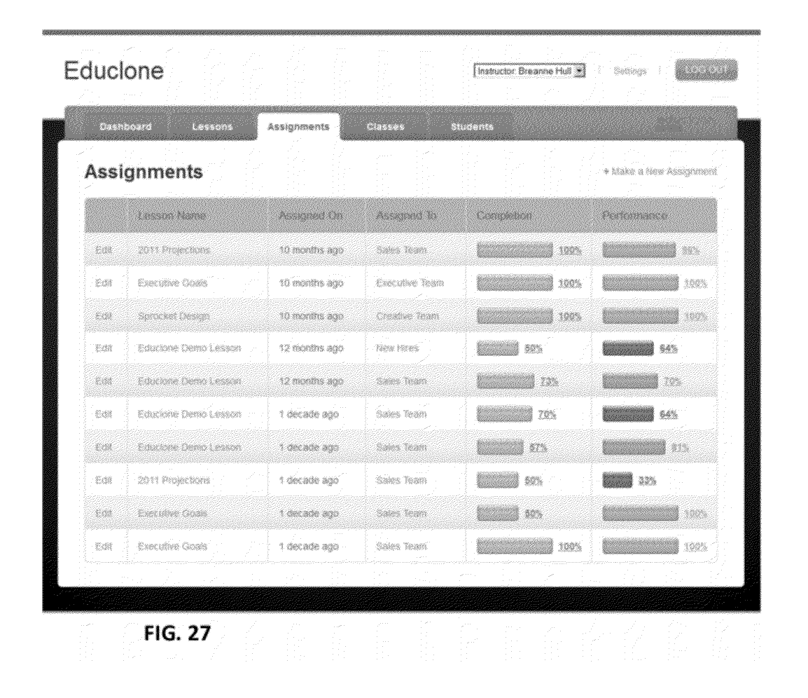

FIG. 27 shows information about assignments, links to enable a teacher to edit current assignments and links to enable the teacher to make new assignments, according to one embodiment.

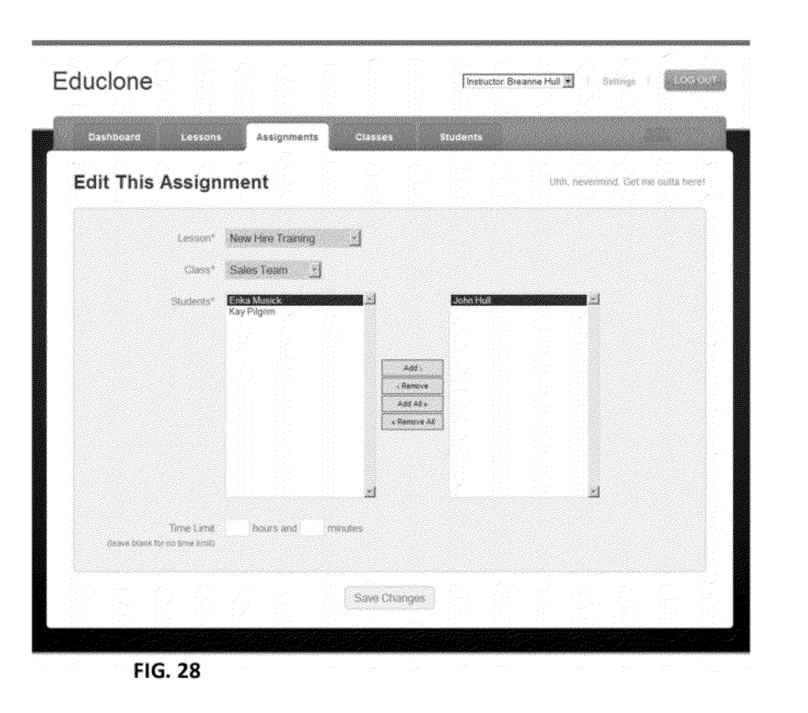

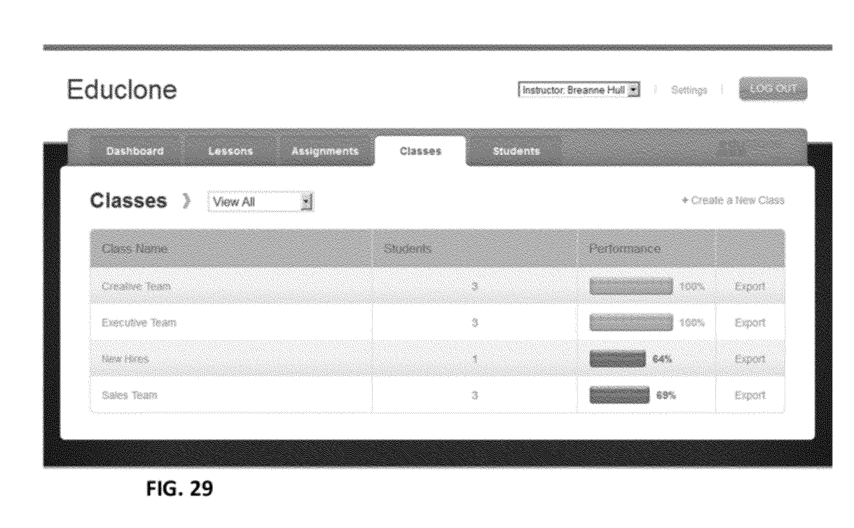

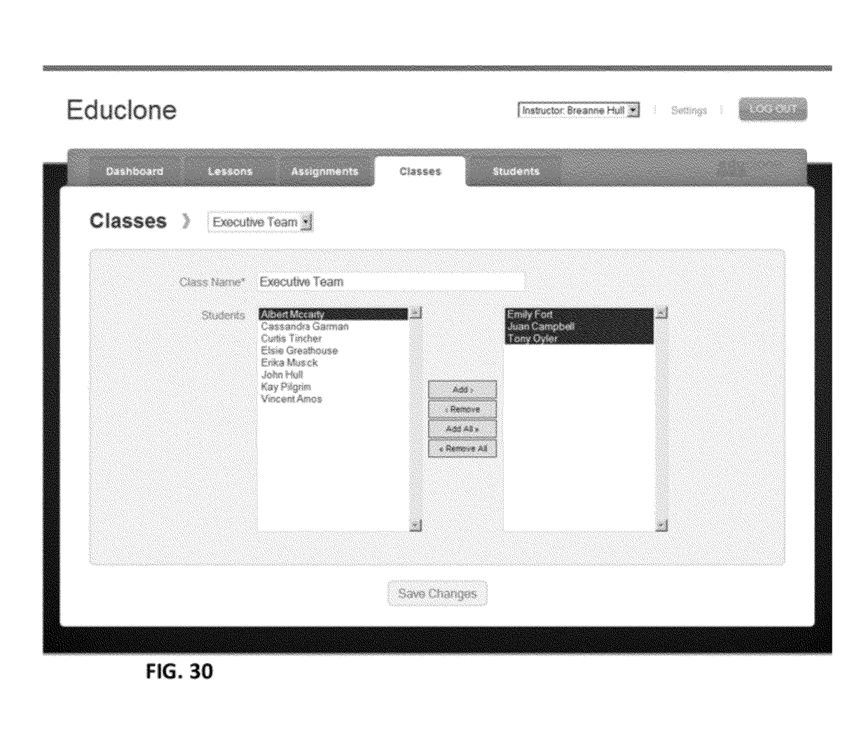

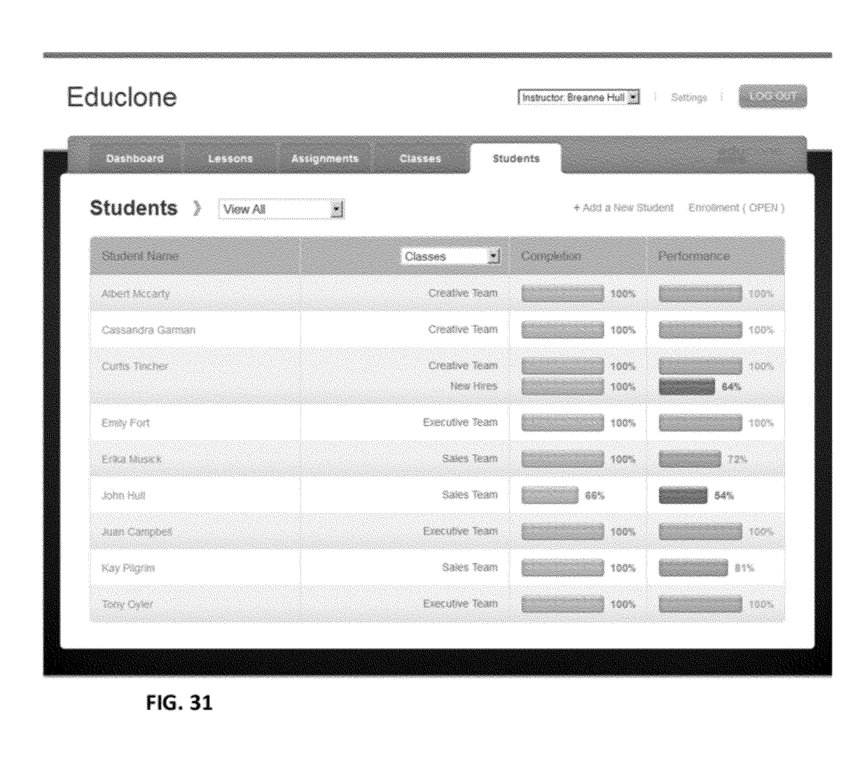

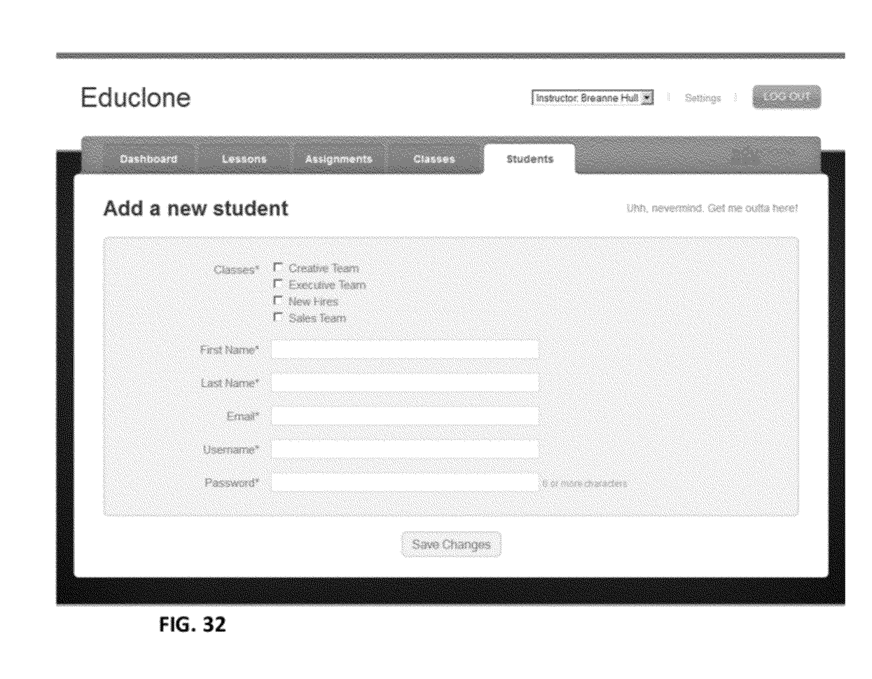

FIG. 28 illustrates a webpage by which a teacher is able to make edits to an existing assignment, according to one embodiment. FIG. 29 shows information about classes supported by the system and a link to enable the teacher to create new classes, according to one embodiment. FIG. 30 illustrates a webpage by which a teacher is able to add/remove students to/from particular classes, according to one embodiment. FIG. 31 shows student information for a particular teacher, according to one embodiment. FIG. 32 illustrates a webpage by which a teacher is able to add a new student, according to one embodiment.

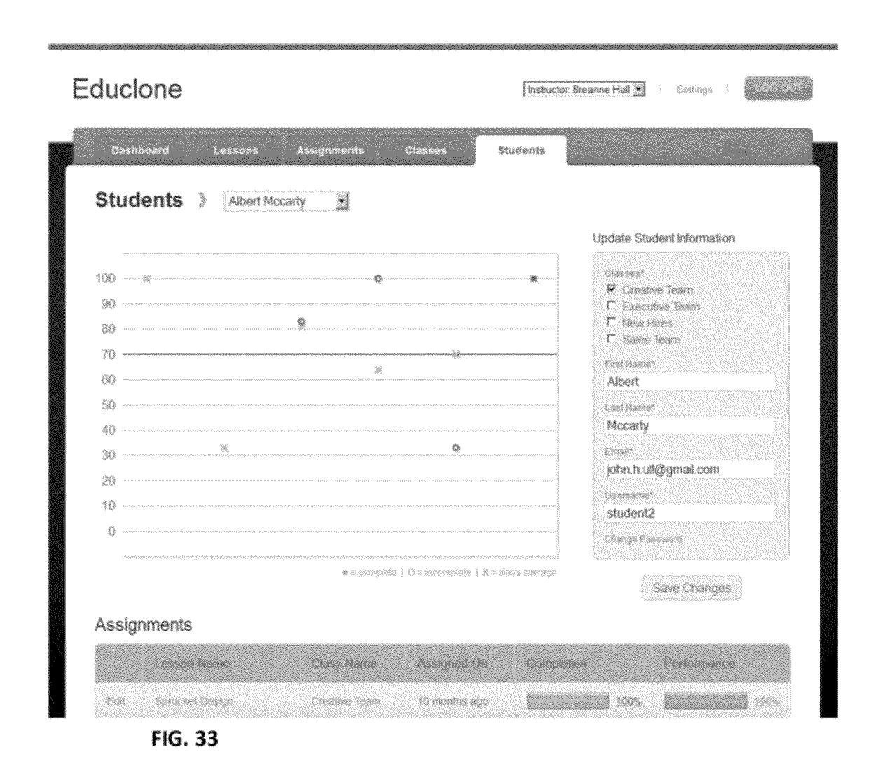

FIG. 33 shows information about assignment completion and performance by a particular student, according to one embodiment. As students complete the self-paced lessons, the system provides teachers with live feedback on student performance, both percentage of completion of assigned lessons and performance. The student detail page shows student performance on assigned lessons as compared to his or her class average. The facilitator is able to compare individual performance relative to others within the same class, or to other students and classes historically. Furthermore, based on the available performance metrics, either the facilitator or participant student is enabled to print certifications of completion for various assignments and classes.

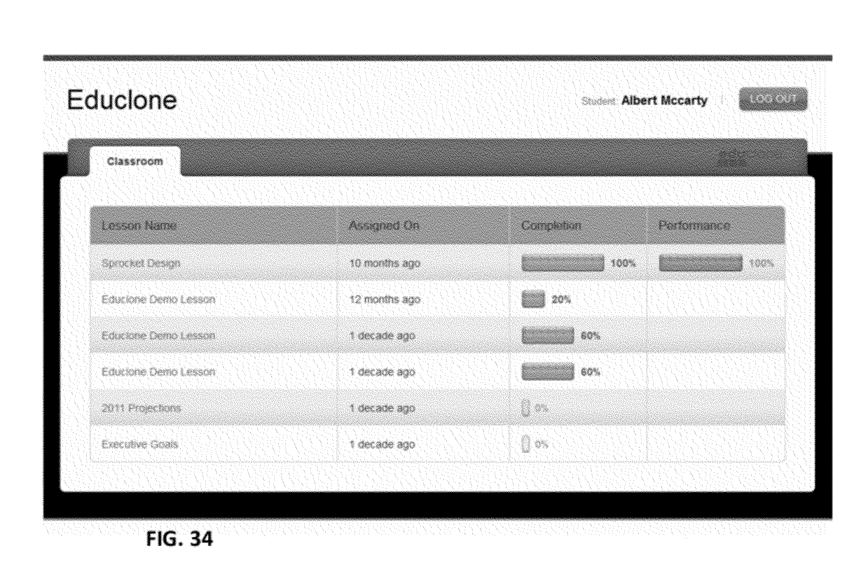

FIG. 34 shows information about lesson assignment for a particular student, according to one embodiment.

Features of the described embodiments can be realized in hardware or a combination of hardware, firmware and/or software. An example combination of hardware and firmware and/or software can be an application specific integrated circuit (ASIC) or other programmable module. Additional features of the described embodiment may be implemented within a general-purpose data processing system with a computer program/utility that, when loaded and executed, enables the physical pointing device to control operations of other program applications, the operating system and the computer system in general, such that the system performs one or more of the methods described herein.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The described embodiments are to be considered in all respects only as illustrative and not restrictive. It will be apparent to those skilled in the art that various modifications and variations can be made in the systems and methods of delivering educational content online of the present disclosure and in construction of this disclosure without departing from the scope or intent of the disclosure.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for enabling a facilitator to provide access to educational content, the method comprising the steps of:
the facilitator specifying a plurality of content blocks, said plurality of content blocks further comprised of a plurality of interaction segments and a plurality of assessment segments;
the facilitator providing a plurality of content components within said content blocks;
the facilitator arranging the placement of each of the plurality of content blocks; and
providing a participant with an ordered access to said plurality of content blocks.

2. The method of claim 1, further comprising executing said plurality of content blocks in order based on specification by said facilitator.

3. The method of claim 1, further comprising rearranging at least one of said plurality of content components or said plurality of content blocks at will.

4. The method of claim 1, further comprising inserting or deleting at least one of said plurality of content components or said plurality of content blocks at will.

5. The method of claim 1, further comprising assessing a performance of said participant on at least one assessment segment.

6. The method of claim 6, further comprising dynamically determining subsequent access to content blocks based on said performance.

7. The method of claim 1, further comprising providing feedback to said participant based on participant's responses to said plurality of assessment segments.

8. The method of claim 1, wherein said plurality of assessment segments are further comprised of formative assessment items and summative assessment items.

9. The method of claim 1, further comprising the step of monitoring a plurality of performance metrics for said plurality of content blocks.

10. The method of claim 9, further comprising allocating a set of resources based on said plurality of performance metrics.

11. The method of claim 9, further comprising archiving of said plurality of performance metrics within a database.

12. The method of claim 1, further comprising creating at least one lesson from said plurality of content blocks.

13. The method of claim 12, further comprising selecting and assigning of at least one lesson to said participant.

14. A system for enabling a facilitator to provide access to educational content, the system comprising:
a plurality of content blocks specified by a facilitator, said content blocks comprised of a plurality of interaction segments and a plurality of assessment segments;
a plurality of content components provided by said facilitator within said content blocks for organizing a lesson;
a dashboard provided to organize access to said lesson; and
a data processing module adapted to determine a set of performance metrics for at least one participant by monitoring participant progress and responses to said assessment segments.

15. The system of claim 14, further comprising a content processor for making edits within said content components of said lesson.

16. The system of claim 14, wherein said participant may be an individual or at least one class.

17. The system of claim 14, wherein said assessment segments are further comprised of formative assessment items and summative assessment items.

18. The system of claim 14, further comprising a website, which further comprises one or more web pages containing said plurality of content blocks.

19. The system of claim 14, further comprising a remote access device for allowing remote access to said dashboard.

20. The system of claim 14, wherein said data processing module further comprises a channel for engaging at least one participant individually.
